(19) United States
(12) Patent Application Publication
(10) Pub. No.: US 2004/0235451 A1
(43) Pub. Date: Nov. 25, 2004

(54) Variable rate billing methods

(76) Inventors: Jean E. Whewell, Georgetown, TX (US); Christopher J. Whewell, Georgetown, TX (US)

Correspondence Address: Christopher J. Whewell, Western Patent Group, 6020 Tonkowa Trail, Georgetown, TX, 78628, US

(21) Appl. No.: 10/876,938

(22) Filed: Jun. 26, 2004

Related U.S. Application Data
(63) Continuation-in-part of application No. 10/230,852, filed on Aug. 29, 2002.

(51) Int. Cl. H04M 15/00

(52) U.S. Cl. 455/406; 455/407; 455/408

(57) ABSTRACT

Provided herein is a variable billing plan which calculates the lowest possible invoice amount to be billed to a consumer of various goods and/or services, including without limitation cellular services, from a variety of billing options. Through use of a billing method according to the invention, consumer loyalty is increased at negligible expense to bandwidth consumption.

### CROSS-REFERENCES TO RELATED APPLICATIONS

This application is a continuation-in-part of U.S. patent application Ser. No. 10/230,852 filed on Aug. 29, 2002, the entire contents of which are herein incorporated by reference.

### TECHNICAL FIELD

This invention relates to methods by which a vendor of goods and/or services may generate an invoice for billing to the user of such goods and/or services. Methods according to the present invention are suitable for, inter alia, billing users of cellular telephone service.

### BACKGROUND INFORMATION

Cellular telephone services are in widespread use. Providers of such services offer different billing plans to prospective customers under which the different plans have differing amounts of threshold levels of minutes that a user may consume for a flat fee. If the user exceeds the threshold amount of plan minutes within a given billing cycle, the user must pay a rate per minute for those minutes used which are in excess of the plan threshold amounts. Often, the rate per minute for minutes used in excess of the plan threshold level of minutes is punitive, in the sense that it is much higher than the rate per minute as calculated from the basic plan amount divided by the number of threshold minutes permitted under such a plan. This puts the consumer at a disadvantage as far as cost is concerned with respect to minutes consumed beyond the plan permitted (or threshold) amount, and nearly always causes negative feelings in the mind of the consumer towards the service provider, which typically prompts consumers to seek alternative sources of cellular services; thus, such plans are inherently detrimental to loyalty. It would therefore be of commercial benefit if a billing plan or method existed which does not instill the felling in the minds of consumers that they are being penalizing for un-planned use of cellular services in excess of the amount initially believed by the user to be applicable to their requirements. Employment of a plan having such features would increase consumer loyalty to a provider of cellular, and other services.

### SUMMARY OF THE INVENTION

One embodiment of the present invention provides a variable billing plan method for calculating an invoice amount for a consumer of cellular telephone services during a service interval. A method according to one embodiment of the invention comprises the steps of: a) offering a consumer a plurality of billing schemes, plans, or schedules from which to choose, wherein each of the schedules includes a pre-determined threshold level of given plan minutes which are billed at a flat rate, and a rate per minute for each minute of service used which exceeds the threshold level, and wherein each of the plurality of billing schedules offered includes a different amount of pre-determined threshold level of given plan minutes; b) accepting a billing schedule choice selection from the consumer, wherein the choice includes a pre-determined threshold level of given plan minutes which are billed at a flat rate and a rate per minute for each minute of service used which exceeds the threshold level; c) providing cellular telephone service to the consumer during a service interval; d) calculating an invoice amount based upon the accepted billing schedule choice by combining the total dollar values of the flat rate and an addend that is calculated by multiplying the number of minutes of service used that exceed the threshold level by the rate per minute charged for each minute exceeding the threshold level; e) calculating a hypothetical invoice amount based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected; f) repeating step e) for each of all of the plans offered but not selected, so as to provide a hypothetical invoice amount for each plan not selected; g) comparing the hypothetical invoice amount(s) with the invoice amount from step d) to determine which out of all of the invoice amount and the hypothetical invoice amount(s) is the least dollar value; and h) issuing an invoice to the customer using the least dollar value as a pre-tax basis for the invoice.

In another embodiment is provided a method for a provider of goods and/or services to determine an amount to be charged to a customer for the consumption or use of one or more goods or services, which method comprises the steps of: a) obtaining a consumption value based on the consumption by a customer of one or more goods or services during a service interval; b) calculating a plurality of invoice amounts using the consumption value as a basis, at least partially, wherein the plurality of invoice amounts include at least one hypothetical invoice amount; c) comparing at least two of the invoice amounts from the plurality of invoice amounts with one another, wherein at least one of the invoice amounts being compared is a hypothetical invoice amount; and d) selecting one of the invoice amounts from the plurality of invoice amounts.

A general method according to the invention is characterized in one respect as having the benefit that it does not create a perception in the mind of a consumer of goods and/or services that they are being penalized for fluctuations in their usage from one time period of consumption/use to the next, which leads the consumer to remain loyal to the supplier/provider employing the methods of the present invention.

### DETAILED DESCRIPTION

Cellular service providers offer the public different billing plans from which each individual user may choose, which best suits their personal calling needs. Typically, such services offer several different billing schedules to prospective customers to entice them to enter into contractual obligations with the service provider. Typically, the billing schedules offered include a pre-determined threshold level of minutes that the consumer may use, in exchange for a flat billing amount. In the event that the consumer utilizes more minutes of cellular service than specified as the pre-determined threshold level, the consumer is billed on a per-minute basis for each minute in excess of the threshold level of minutes in the plan accepted by the consumer. The invoice at the end of the service interval, which is typically monthly, is calculated by adding the total dollar values of the flat rate and an addend that is calculated by multiplying the number of minutes of service used that exceed the threshold level by the rate per minute charged for each minute exceeding the threshold level. Taxes and other fees may then be added on and a final invoice amount is billed to the consumer.

A typical offering of a plurality of billing schedules is set forth below in Table I:

TABLE I
common plurality of billing schedule options offered to
consumers of cellular service.

| | Monthly Service | Threshold Level of | Additional |
|---|---|---|---|
| Plan Number | Charge | Minutes | Minutes Cost |
| 1 | $34.99 | 300 | 40 cents |
| 2 | $49.99 | 500 | 40 cents |
| 3 | $74.99 | 1000 | 40 cents |
| 4 | $99.99 | 1300 | 40 cents |
| 5 | $149.99 | 2200 | 40 cents |
| 6 | $199.99 | 3200 | 40 cents |

Thus, a consumer operating under plan 1 who used 400 minutes per service interval would be invoiced an amount equal to the monthly service charge of $ 34.99 plus an additional $ 40.00, derived from multiplying 100 minutes excessive of the threshold level of 300 minutes times the rate of 40 cents per minute.

Similarly, a consumer operating under plan 1 who used 600 minutes during the service interval would be invoiced based on an amount of $ 34.99 plus $ 120.00.

Certainly, it is to the consumer's advantage to select the plan which is best suited to their individual needs at the time of acceptance of a contract. However, prediction of service usage by consumers is not always accurate due to fluctuating individual needs. If a cellular service provider were to offer their consumers and prospective consumers a variable-rate billing plan which saved the consumer money during unpredictable fluctuations in their service, the consumer would appreciate the cost savings that such a variable billing plan would offer. A cellular service provider which offered a variable billing plan according to the invention would be very likely to attract customers away from their competition, and would appreciate significant long-term overall financial gains relative to their competition realized by an increased subscriber base, with relatively little increase in bandwidth usage.

According to the present invention the regular amount that a consumer would be billed under an accepted billing schedule is calculated. Then, a hypothetical invoice amount is calculated based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected. This is repeated for each of the plans that were offered but not selected, so as to provide a hypothetical invoice amount for each plan not selected. Then, the hypothetical invoice amount(s), (when more than two plans were offered to the consumer) are compared with the regular amount that the consumer would be billed under the accepted billing schedule (the “actual amount”) to determine which dollar value out of all of the hypothetical and actual amounts is the lowest cost to the consumer. The lowest value is selected as a basis for invoicing the customer, to which taxes and other customary fees are added to yield a final invoice amount that must be paid by the consumer.

In one preferred embodiment of the invention, in exchange for the valuable variable billing plan according to the invention, the consumer of cellular services is levied a surcharge on their invoice for the use of the variable plan of the invention.

Thus, a consumer of cellular services operating under plan 1 of Table I who uses 400 minutes in the service interval would have an actual amount for billing as set forth in Table III below next to plan 1, with the rest of the dollar values being the hypothetical invoice amounts:

TABLE II
Invoice amounts for person operating under plan 1 from
Table I who uses 400 minutes of service during the
service interval.

| Plan Number | Invoice Amounts |
|---|---|
| 1 | $74.99 (actual) |
| 2 | $49.99 (hypothetical) |
| 3 | $74.99 (hypothetical) |
| 4 | $99.99 (hypothetical) |
| 5 | $149.99 (hypothetical) |
| 6 | $199.99 (hypothetical) |

According to the present invention, the dollar figures from the right-hand column of Table II would be compared with one another to discover that the lowest dollar amount is $ 49.99. This is the amount that would be used as a basis for calculating the consumer's invoice, in one embodiment saving the consumer $ 30.00. The service provider, in one embodiment, would charge the consumer a surcharge for the use of a plan according to the present invention, which may be any amount between 0 and the amount saved. While it is most preferred that the surcharge is about one-half of the savings to the consumer, the present invention contemplates surcharges which are any dollar value between zero and the amount saved through use of the plan.

As another example, a consumer operating under plan 1 in Table I who uses 600 minutes of service would have an actual amount for billing as set forth in Table III below next to plan 1, with the rest of the dollar values being the hypothetical invoice amounts:

TABLE III
Invoice amounts for person operating under plan 1 from
Table I who uses 600 minutes of service during the
service interval.

| Plan Number | Invoice Amounts |
|---|---|
| 1 | $154.99 (actual) |
| 2 | $89.99 (hypothetical) |
| 3 | $74.99 (hypothetical) |
| 4 | $99.99 (hypothetical) |
| 5 | $149.99 (hypothetical) |
| 6 | $199.99 (hypothetical) |

Thus, the lowest billing amount for a person operating under plan 1 who uses 600 minutes of service but calculated according to a method of the present invention would be $ 74.99. This could represent a maximum amount of savings of $ 80.00 to the consumer.

Use of a variable billing method according to the invention not only attracts consumers away from competitors in the cellular service market, but also saves consumers money while not adversely impacting bandwidth usage, all while—perhaps most importantly—increasing consumer loyalty.

Thus, in view of the foregoing discussion, which uses cellular telephone service as an example, it has been illustrated that in instances where a provider of goods and/or services offers a plurality of billing plan options to current and potential future consumers of goods and/or services that they provide, the present invention provides a new general method or scheme by which such consumers may be billed, charged, invoiced, or otherwise held to account for consumption or use of the goods and/or services. The methods of the present invention are equally applicable to many other fields of commerce, and should not be construed as being limited solely to cellular telephone service.

In one broad respect, a method according to a preferred embodiment of the invention utilizes a consumption value of a good or service by a customer to calculate an invoice amount. The consumption value itself is a direct measure of the actual good(s) or service(s) consumed by the customer during any interval of time which is conveniently termed the service interval. As used in this specification and the claims appended hereto, the words “consumption value” means a numerical value which is proportional to, represents, or otherwise reflects to the actual consumption or use of good(s) and/or service(s) by a consumer or customer of such goods and/or services. The consumption value is often measured by the provider of the goods and/or services, using means known to those skilled in the art of commerce, such as a watt-hour meter on a building, a gas meter, a computer-generated tabulation of cellular service minutes, gallons of fuel pumped, etc. The consumption value for goods and/or services is generally obtained or tabulated by the provider of goods and/or services routinely during the course of supplying the goods and/or services to the consumer or customer. The consumption value may be a direct measure of actual goods or services utilized during a service interval, or may be arrived at by calculation employed by the service provider. For example, in the case of electrical power, it can be argued that the actual use electrical service, in rem, is electrical current delivered at a specified voltage. Those skilled in the electrical arts have found it convenient to calculate wattage, as a product of current and voltage. When combined with the time factor, the value of watt-hours may be obtained, as but one measure of the consumption of electron flow, although other values reflective of a measure of consumption are possible, such as Joules per month. Regardless of the semantics and units, the consumption value is some measure of actual goods and/or services used. The consumption value is used in the calculation of an invoice amount, which may include all mathematic operations known in the art, including without limitation multiplication, division, addition, and subtraction. In addition, average or time-weighted values for consumption values may be obtained and used, in addition to other basises, as a basis upon which a hypothetical or actual invoice amount is calculated, in combination with the terms of one or more existing contract(s) under which a customer/consumer is bound, or one which is or was offered to the consumer prior to or during use or consumption of goods and/or services. In the example of cellular telephone services above, the consumption value is the minutes of services utilized during the service interval, and this consumption value is used in the calculation of the invoice amount, in dollars, for example, by simple calculation under a billing plan. A method according to the invention takes into consideration the consumption value from a service interval, and calculates a plurality of invoice amounts, using the consumption value of the customer during the service interval. The plurality of invoice amounts are calculated using a plurality of billing plans. The plurality of billing plans may include two or more billing plans offered by the provider of the good(s) or service(s) either before or after the acceptance by the customer of a contract with the provider. The plurality of billing plans used to calculate the invoice amount may also include one or more billing plans offered by a competitor of the provider, at any point in time. The invoice amounts calculated using a consumption value of a customer during a service interval and a plurality of billing plans offered by either the provider or the provider's competition, or both, which plurality of billing plans were not selected by the consumer in a contract, are referred to herein as hypothetical invoice amounts.

A service interval may be defined on a per-time basis, such as per minute, per hours, per day, per month, per annum, etc. Individual consumption values may be denominated in a wide variety of units, including without limitation the following: monetary units, such as in the case of when money is lent according to the invention, time units, (either calculated straight, or as a combination of two or more different time segments, as in the case of cellular telephone usage that is billed at a threshold level plus an addend, to cite but one non-delimitive example), or in quantity of goods and/or services consumed, which are typically in units selected from the group consisting of: units of weight, units of electrical power, such as expressed in kilowatt hours, units of distance traveled, or any measure known in the art under which a measure of goods and/or services sold is determined or specified.

In one embodiment, the service interval is measured in time units of minutes, hours, days, weeks, months, & cet, and the individual consumption values are denominated in time units of usage, such as minutes of cellular service per month. In another embodiment, the service interval is measured in time units of minutes, hours, days, weeks, months, & cet, and the usage value is denominated in units of weight, units of electrical power, such as kilowatt hours or an equivalent thereof, units of distance traveled, BTU's of energy consumed, units of volume of liquids or gases purchased or consumed, units of area, such as square meters of coatings, floor coverings, and acres fertilized; and units of length, such as length of road surface paved. Thus, a method according to the present invention is broad in its scope and applicability to commerce.

Under a method according to an alternative embodiment of the invention, a first provider of goods and/or services takes into consideration a consumption value generated by a customer during a service interval, and uses this consumption value in calculating invoice amounts (including hypothetical invoice amounts) from at least one billing plan, rate, or scheme it offers, as well as at least one hypothetical invoice amount generated using a billing plan, rate, or scheme offered by a second provider of goods and/or services (at any time), when determining a plurality of invoice amounts for the goods and/or services provided. A method according to a further alternative embodiment of the invention takes into consideration a consumption value generated by a customer during a service interval and uses this consumption value in calculating invoice amounts (including hypothetical invoice amounts) from at least two different billing plans, rates, or schemes, at least two of which are offered by a different providers of the goods and/or services (offered at any time), when determining a plurality of invoice amounts for the goods and/or services provided.

Various methods of comparing the various invoice amounts (including hypothetical invoice amounts) under consideration may be undertaken, and it will often be found to be a useful result of a comparison that one particular invoice amount (including hypothetical invoice amounts) is greater in magnitude than all of the remaining invoice amounts (including hypothetical invoice amounts) being compared. Similarly, it will often be found to be a useful result of a comparison that one particular invoice amount is less than all of the remaining invoice amounts being compared. This is the case for the cellular telephone billing comparison illustrated herein above. However, a wide range of possible criteria in addition to or other than the magnitude of all invoice amounts being compared may be found useful in comparing such invoice amounts with the aim of selecting one as a basis for providing an actual invoice to the customer/consumer, including without limitation the total consumption or use of goods and/or services over an extended time period, or any other attribute or characteristic of the use or consumption by such customers or consumers.

While the present method has been shown and described with respect to cellular telephone billing practices, the concept of the present invention is extensible to calculating final invoice amounts which are to be billed to a customer or consumer for other goods/services than cellular phones and service, including without limitation: energy, including electricity and all forms of fossil fuels such as natural gas, crude oil, heating oil, etc.; food products, including such commodities as corn, swine, sheep, soybeans, etc.; durable goods, including motorized vehicles, aircraft, construction supplies, etc.; and basically anything of value for which valuable consideration is tendered in exchange therefore, either at the time of purchase, or under any time arrangements.

The present invention also provides an invoicing plan which comprises: a) calculation of at least one hypothetical invoice amount using a consumption value that is reflective of the consumption by a customer of one or more goods and/or services during a service interval according to the terms of a billing plan to which the customer is not contractually bound; and b) comparison of the at least one hypothetical invoice amount with an invoice amount the customer is contractually obligated to pay for such goods and/or services; and c) charging the customer an invoice amount which is based on selection criteria. In one preferred embodiment, the selection criteria are determined by the provider of the goods and/or services. In another embodiment, the selection criteria are fixed for at least two consecutive billing cycles, and in another embodiment the selection criteria are variable from one billing cycle to the next. The selection criteria are preferably based at least in part, on the usage of the goods and/or service by the customer over one or more service intervals. In one embodiment, the selection criteria are based at least in part on which of the plurality of invoice amounts is the highest dollar equivalent value. In one embodiment, the selection criteria are based at least in part on which of the plurality of invoice amounts is the least dollar equivalent value. Another embodiment involves applying a surcharge to the invoice amount charged to the customer for the use of the invoicing plan. Another embodiment involves selecting an invoice amount from amounts within the set of at least one hypothetical invoice amount and the amount the customer is contractually obligated to pay. Another embodiment includes application of a surcharge to the invoice amount charged to the customer for the use of the invoicing plan.

The invention also provides a method of advertising for providers that supply goods and/or services to customers, which includes the step of: offering the customers an invoicing plan which changes the amount that the customer is invoiced when the customer's consumption of the goods and/or services fluctuates, over what it would have been in the absence of the invoicing plan, wherein the invoicing plan includes the calculation of at least one hypothetical invoice amount using a consumption value based on the consumption by a customer of one or more goods or services during a service interval according to the terms of a billing plan to which the customer is not contractually bound, and compares the at least one hypothetical invoice amount with the amount the customer is contractually obligated to pay the provider.

A further embodiment of the invention provides a billing plan which provides for the total of the invoices charged to a customer over a plurality of service intervals to remain the same or to be reduced in dollar equivalent value when the customer's consumption of goods and/or services increases from one service interval to another within the plurality of service intervals, with respect to the total amount the customer would have been charged under a contract offered by at least one other provider of the same goods and/or services for such same goods and/or services during the same service intervals.

Another general embodiment of the invention provides a method of advertising cellular telephone services comprising the step of: offering a variable billing plan, wherein said plan enables the total of the invoices charged to a customer over a plurality of service intervals to be reduced if the customer's usage fluctuates from one service interval to another, as compared to the total amount the customer would have been invoiced under any single contract offered to the customer by any provider of such services in the marketplace for the same quantity of service over the same service intervals.

Yet another general embodiment of the invention provides a billing method which is capable of causing the amount which a consumer of goods and/or services is invoiced to remain the same or to be reduced when the customer's usage increases, versus what the consumer would have been invoiced under any one contract offered to the consumer prior to or during consumption of the goods and/or services.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Accordingly, the presently disclosed invention is intended to cover all such modifications and alterations, and is limited only by the scope of the claims which follow.

What is claimed is:

1) A method for a provider of goods and/or services to determine an amount to be charged to a customer for the consumption or use of one or more goods or services, which method comprises the steps of:
a) obtaining a consumption value based on the consumption by a customer of one or more goods or services during a service interval;
b) calculating a plurality of invoice amounts using said consumption value as a basis, at least partially, wherein said plurality of invoice amounts include at least one hypothetical invoice amount;
c) comparing at least two of the invoice amounts from said plurality of invoice amounts with one another, wherein at least one of said invoice amounts being compared is a hypothetical invoice amount; and
d) selecting one of said invoice amounts from said plurality of invoice amounts.

2) A method according to claim 1 further comprising the step of: e) charging a customer in an amount of at least said selected invoice amount.

3) A method according to claim 1 wherein said at least one hypothetical invoice amount is calculated using the terms of a billing plan that was offered to said customer by an entity selected from the group consisting of: said provider; a contractee of said provider; and a competitor of said provider, but not accepted by said customer at the time of execution of a contract between said customer and said entity for such goods and/or services.

4) A method according to claim 1 wherein said at least one hypothetical invoice amount is calculated using the terms of a billing plan that is or was offered by a second provider of said goods and/or services that it different than said provider.

5) A method according to claim 4 wherein said second provider is a competitor of said provider.

6) A method according to claim 1 wherein said at least one hypothetical invoice amount is calculated using the terms of a billing plan which includes a pre-determined threshold level of goods or services which are billed at a first rate, and a second rate per unit of goods or services for each unit used which exceeds said threshold level.

7) A method according to claim 1 wherein said at least one hypothetical invoice amount is calculated using the terms of a billing plan which includes a pre-determined threshold level of goods or services which are billed at a flat rate, and a rate per unit of goods or services for each unit used which exceeds said threshold level.

8) A method according to claim 1 wherein the amount to be charged under the selected invoice amount is not the highest dollar equivalent value of all of said plurality of invoice amounts.

9) A method according to claim 1 wherein the amount to be charged under the selected invoice amount is the least dollar equivalent value of all of said plurality of invoice amounts.

10) A process according to claim 1 wherein at least two of said plurality of invoice amounts are calculated using the terms of different billing plans, which billing plans each include a threshold level of goods or services which are billed at a first rate.

11) A process according to claim 10 wherein the different billing plans each include a different threshold level of goods or services which are billed at a first rate.

12) A method according to claim 1 wherein said plurality of invoice amounts include an invoice amount calculated using the terms of a billing plan that was agreed to contractually between said provider and said customer.

13) A method according to claim 6 wherein at least one of said plurality of invoice amounts are calculated by combining the total dollar equivalent value of a flat rate and an addend that is calculated based on the number of units of goods or services used that exceed said threshold level, and a rate per unit charged for each unit exceeding said threshold level.

14) A method according to claim 7 wherein at least one of said plurality of invoice amounts are calculated by combining the total dollar equivalent value of a flat rate and an addend that is calculated based on the number of units of goods or services used that exceed said threshold level, and a rate per unit charged for each unit exceeding said threshold level.

15) A method according to claim 8 further comprising the step of: f) charging the customer a surcharge for being invoiced under said method.

16) A method according to claim 15 wherein said surcharge is effectively levied as a flat rate over a service interval.

17) A method according to claim 15 wherein said surcharge is a fixed value that remains constant over at least two consecutive billing cycles.

18) A method according to claim 15 wherein said surcharge is variable, depending upon the total amount of goods and/or services consumed.

19) A method according to claim 15 wherein said plurality of invoice amounts include an invoice amount calculated using the terms of a billing plan that was agreed to in a contract between said provider and said customer, and wherein said surcharge is any amount between zero and the difference between the invoice amount calculated using the terms of a billing plan that was agreed to in a contract between said provider and said customer and said selected invoice amount.

20) A method according to claim 15 wherein said plurality of invoice amounts include an invoice amount calculated using the terms of a billing plan that was agreed to in a contract between said provider and said customer, and wherein said surcharge is any amount between zero and the difference between the invoice amount calculated using the terms of a billing plan that was agreed to in a contract between said provider and the terms of a billing plan offered by a competitor of said provider.

21) A method according to claim 1 further comprising the step of: crediting the account of said customer in an amount that is between zero and the difference between the invoice amount calculated using the terms of a billing plan that was agreed to in a contract between said provider and said customer, and a hypothetical invoice amount calculated using terms of a billing plan offered by a competitor of said provider.

22) A method according to claim 1 further comprising the step of: crediting the account of said customer in an amount that is between zero and the difference between the invoice amount calculated using the terms of a billing plan that was agreed to in a contract between said provider and said customer, and a hypothetical invoice amount calculated using terms of a billing plan offered by a competitor of said provider, for a substantially equivalent quantity of the same or substantially equivalent goods and/or services over a substantially equivalent service interval.

23) A method according to claim 19 wherein said surcharge is about one-half of the amount saved through use of the method as compared to what the consumer's invoice would have been under the billing schedule chosen by said customer under said contract.

24) An invoicing plan which comprises:
a) calculation of at least one hypothetical invoice amount using a consumption value that is reflective of the consumption by a customer of one or more goods and/or services during a service interval according to the terms of a billing plan to which said customer is not contractually bound; and
b) comparison of said at least one hypothetical invoice amount with an invoice amount said customer is contractually obligated to pay for such goods and/or services;
c) charging said customer an invoice amount which is based on selection criteria.

25) A plan according to claim 24 wherein said selection criteria are determined by the provider of said goods and/or services.

26) A plan according to claim 24 wherein said selection criteria are fixed for at least two consecutive billing cycles.

27) A plan according to claim 24 wherein said selection criteria are variable from one billing cycle to the next.

28) A plan according to claim 24 wherein said selection criteria are based at least in part, on the usage of said goods and/or service by said customer over one or more service intervals.

29) A plan according to claim 24 wherein said selection criteria are based at least in part on which of said plurality of invoice amounts is the highest dollar equivalent value.

30) A plan according to claim 24 wherein said selection criteria are based at least in part on which of said plurality of invoice amounts is the least dollar equivalent value.

31) A plan according to claim 24 further comprising the step of: d) applying a surcharge to the invoice amount charged to the customer for the use of said invoicing plan.

32) A plan according to claim 24 further comprising the step of: selecting an invoice amount from amounts selected from the group consisting of: said at least one hypothetical invoice amount and said amount said customer is contractually obligated to pay.

33) A plan according to claim 32 further comprising the step of: applying a surcharge to the invoice amount charged to the customer for the use of said invoicing plan.

34) A method of advertising for providers that supply goods and/or services to customers, which includes the step of: offering said customers an invoicing plan which changes the amount that the customer is invoiced when the customer's consumption of said goods and/or services fluctuates, over what it would have been in the absence of said invoicing plan, wherein said invoicing plan includes the calculation of at least one hypothetical invoice amount using a consumption value based on the consumption by a customer of one or more goods or services during a service interval according to the terms of a billing plan to which said customer is not contractually bound, and compares said at least one hypothetical invoice amount with the amount said customer is contractually obligated to pay said provider under an existing contract.

35) A billing plan which provides for the total of the invoices charged to a customer over a plurality of service intervals to remain the same or to be reduced in dollar equivalent value when the customer's consumption of goods and/or services increases from one service interval to another within said plurality of service intervals, with respect to the total amount said customer would have been charged under a contract offered by at least one other provider of the same goods and/or services for such same goods and/or services during the same service intervals.

36) A method of advertising cellular telephone services comprising the step of: offering a variable billing plan, wherein said plan enables the total of the invoices charged to a customer over a plurality of service intervals to remain constant or be reduced if the customer's usage fluctuates from one service interval to another, as compared to the total amount the customer would be invoiced under the terms of at least one other single contract offered to the customer by any provider of such services in the marketplace for substantially the same quantity of service over a service interval of substantially the same length, wherein said at least one other single contract is made available or offered to said customer after said customer has already executed a contract for such services.

37) A method of advertising cellular telephone services comprising the step of: offering a variable billing plan, wherein said plan enables the total of the invoices charged to a customer over a plurality of service intervals to remain constant or be reduced if the customer's usage fluctuates from one service interval to another, as compared to the total amount the customer would be invoiced under the terms of at least one other single contract offered to the customer by any provider of such services in the marketplace for substantially the same quantity of service over a service interval of substantially the same length, wherein said at least one other single contract is made available or offered to said customer before said customer has executed a contract for such services.

38) A billing method which is capable of causing the amount which a consumer of goods and/or services is invoiced to remain the same or to be reduced when the customer's usage increases, versus what said consumer would have been invoiced under any one contract offered to said consumer prior to or during consumption of said goods and/or services.
